(19) United States
(12) Patent Application Publication
(10) Pub. No.: US 2003/0107272 A1
(43) Pub. Date: Jun. 12, 2003

(54) Cam driven switch and overdrive protection method

(76) Inventors: Lothar Westerweck, Hollywood, FL (US); Wilfried Bittner, Hong Kong (CN)

Correspondence Address: Concord Camera Corp., Suite 650N, 4000 Hollywood Blvd., Hollywood, FL, 33021, US

(21) Appl. No.: 10/013,331

(22) Filed: Dec. 10, 2001

(51) Int. Cl. H02B 1/24

(52) U.S. Cl. 307/119

(57) ABSTRACT

An overdrive protection system and method for a mechanical assembly is provided. A cam gear is provided for driving a part. The cam gear includes a cylindrical outer surface is bounded on one end by a gear drive portion and on the other end by a cam face including a cam wedge. Additionally a cam groove is defined on the cylindrical outer surface of the cam gear, the cam groove engaging a cam follower on the driven part. Rotational movement of the cam gear is translated into a resultant linear movement of the part. At a predetermined position during the rotation of the cam gear, the cam wedge closes a switch, stopping the rotation of the cam gear preventing over rotation of the cam gear. A bias mechanism, such as a leaf spring, may be provided to prevent over rotation of the part driven by the cam gear.

### RELATED CASES

The present invention is related to U.S. patent application Ser. No. 09/493,355, entitled, COMPACT THROUGH THE LENS DIGITAL CAMERA.

### FIELD OF THE INVENTION

The present invention relates to the field of mechanical assemblies, and more particularly, to a cam driven switch and overdrive protection method for a mechanical assembly.

### BACKGROUND OF THE INVENTION

Cylindrical cams are used in a number of different types of mechanical assemblies. What is needed is a cam driven switch that is operable based on the rotation and/or position of a cam cylinder. What is further needed is an overdrive protection mechanism including a cam cylinder driven switch.

These and other objects and advantages of the present invention will become more readily apparent in the description that follows.

### SUMMARY OF THE INVENTION

The present invention is directed to an overdrive protection mechanism. A cam driven switch is operable based on the rotational position of a cam gear. It is an object of the present invention to provide a cam driven switch used to stop the rotation of the cam gear at a predetermined point during the rotation. It is an object of one particular embodiment of the present invention to provide a cam driven switch which turns off a motor driving the cam to prevent over-rotation of the cam.

These and other objects and advantages of the present invention will become more readily apparent in the description that follows.

### BRIEF DESCRIPTION OF THE DRAWINGS

The foregoing summary, as well as the following detailed description of the preferred embodiments, is better understood when read in conjunction with the appended drawings. For the purpose of illustrating the invention, there is shown in the drawings an exemplary embodiment that is presently preferred, it being understood, however, that the invention is not limited to the specific methods and instrumentalities disclosed. In the drawings:

FIG. 1A shows a front perspective view taken from the left side of one embodiment of a cam gear useful with the present invention.

FIG. 1B shows a rear perspective view taken from the right side of the cam gear of FIG. 1.

FIGS. 2A-2C show end views of an exemplary cam driven switch in accordance with one embodiment of the present inventions.

FIG. 3 shows a simplified partial top plan view of an exemplary system including an overdrive protection mechanism in accordance with one particular embodiment of the present invention.

FIG. 4A shows a perspective view of an exemplary mirror drive sub-assembly including an overdrive protection mechanism in accordance with one specific embodiment of the present invention.

FIG. 4B shows a top plan view of an exemplary mirror drive sub-assembly including an overdrive protection mechanism in accordance with one specific embodiment of the present invention.

### DETAILED DESCRIPTION OF THE PREFERRED EMBODIMENTS

Before explaining the disclosed embodiment of the present invention in detail, it is to be understood that the invention is not limited in its application to the details of the particular arrangement shown since the invention is capable of other embodiments. Also, the terminology used herein is for the purpose of description and not of limitation.

The present invention is useful in a number of systems, but is of particular use in a digital camera of the type described in U.S. patent application Ser. No. 09/493,355, assigned to the present assignee, that application incorporated herein by reference in its entirety.

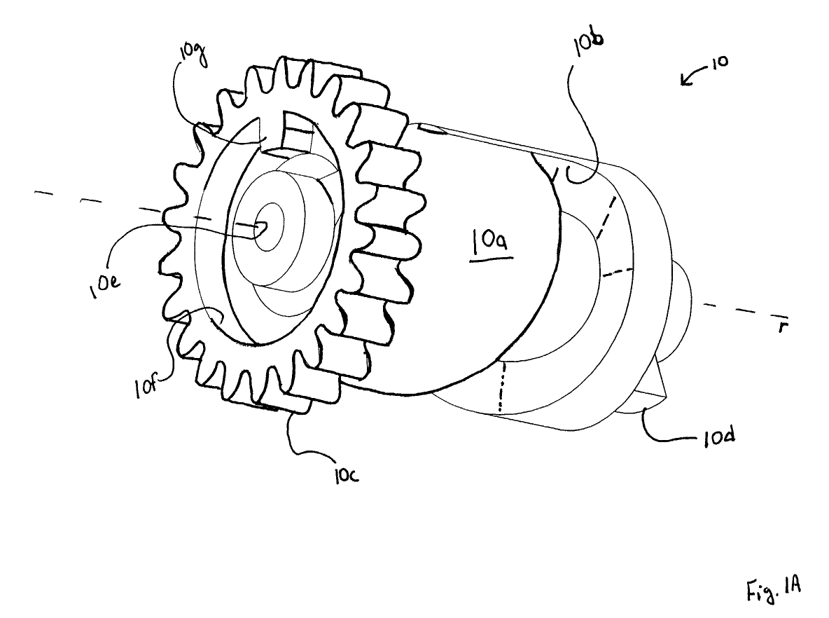

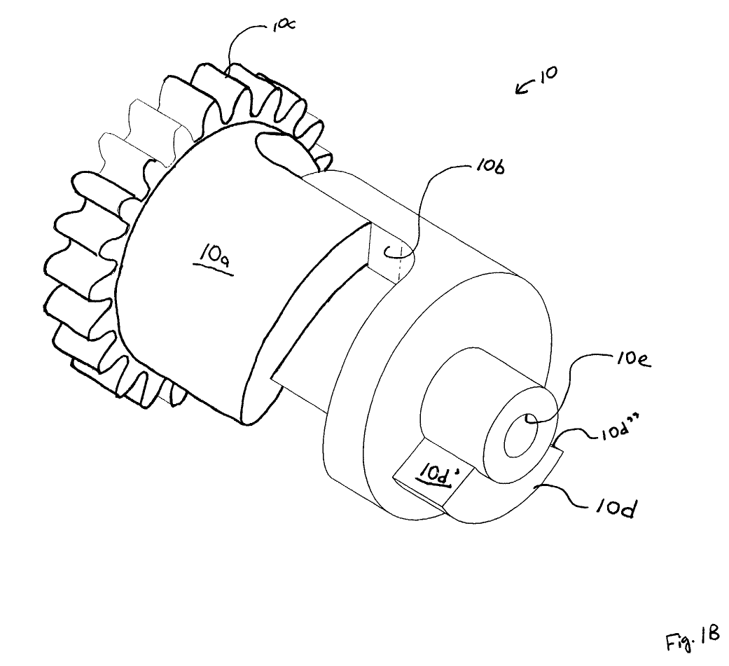

Referring now to FIGS. 1A and 1B, there is shown a cam gear 10 useful with one embodiment of the present invention. The cam gear 10 comprises a substantially cylindrical-shaped body having an outer surface 10a. A channel 10b extending across the outer surface 10a is structured and disposed to slidingly engage a cam follower from another part. The channel 10b comprises a spiral cam groove that encircles the cam gear 10. The shape and form of the cam groove 10b will be dictated by the desired path motion of the part driven by the cam gear 10

Disposed at the front end of the cam gear 10 is a gear drive portion 10c. At the rear of the cam gear 10 is a cam wedge 10d. A bore 10e sized to receive a guide pin passes through the cam gear 10. A rotational axis “r” is defined through the center of the bore 10e of the cam gear 10.

The cam wedge 10d is located on the end of the cam gear 10 and is used to implement a desired action at a predetermined point during the rotation of the cam gear 10. In one particular embodiment, the cam wedge 10d helps to define a desired range of rotation of the cam gear 10, by determining when to stop the motor controlling the rotation of the cam gear 10. Cam wedge 10d includes a leading edge 10d′ and a trailing edge 10d″. Placement of the leading and trailing edges of the cam wedge 10d defines the portion used of the cam groove 10b.

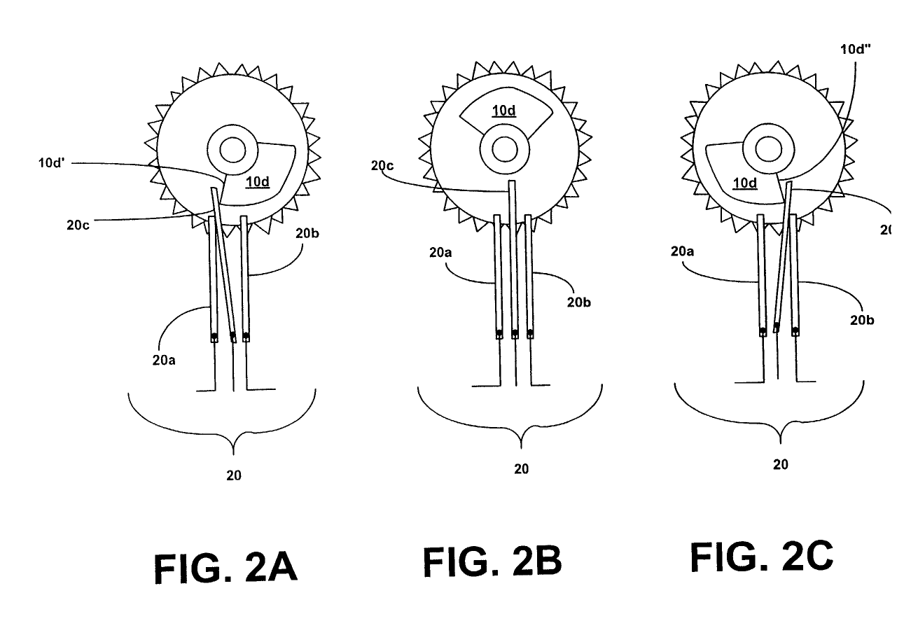

Referring now to FIGS. 2A, 2B and 2C, there is shown a cam driven switch 20 in accordance with one embodiment of the present invention. The cam driven switch comprises first and second stationary contacts, 20a and 20b respectively, and a taller spring contact 20c. The switch 20 has three main positions embodied in FIGS. 2A, 2B and 2C. In a first position, the switch is closed when the cam gear 10 is rotated such that the first leading edge 10d′ of the cam wedge 10d passes over the stationary contact 20b, contacts and bends the spring contact 20c, causing it to contact stationary contact 20a. In the open position, the cam gear 10 rotates and neither leading edge 10d′ nor trailing edge 10d″ contacts the spring contact 20c. In the third main position, the cam wedge closes the circuit by rotating such that the trailing edge 10d′ passes over the stationary contact 20a and bends the spring contact 20c, causing it to contact stationary contact 20b.

In the particular embodiment shown, the cam wedge 10d exists over about 100 degrees of rotation of the cam gear 10, permitting the cam gear to rotate about 260 degrees from the leading edge 10d′, before closing the switch 20 again with trailing edge 10d′ and vice versa. This is not meant to be limiting. Rather, the cam wedge 10d may be made larger or smaller. It is additionally contemplated that the cam wedge may omit the “wedge” shape and, instead, include on its end face two protrusions that function as the leading and trailing edges of the wedge.

An important factor in sizing the cam wedge 10d is choosing the location of the leading and/or trailing edges to close the switch 20 based on the desired amount of rotation of the cam gear 10. For example, if it is desired that the cam gear close the switch 20 after a 50 percent rotation of the cam gear 10, than the leading and trailing edges of the cam wedge would be located 180 degrees of rotation apart.

As an alternative to the switch 20 of FIGS. 2A-2C, the end contacts 20a and 20b may be replaced with spring contacts that of the same height or taller than the middle contact 20c and which are bent by the cam wedge towards the stationary middle contact 20c.

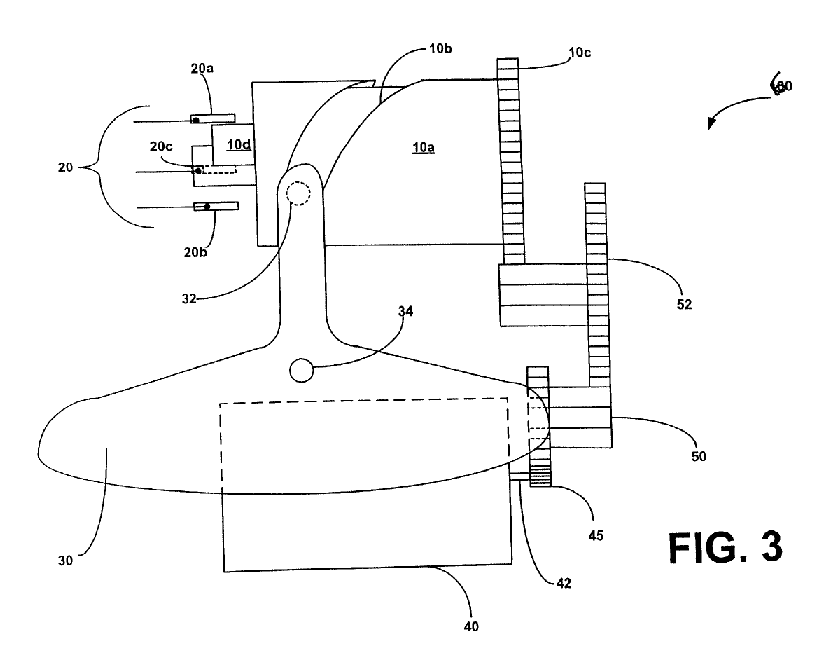

Referring now to FIG. 3, the operation of the cam driven switch will be described in the context of one particular example. The cam gear 10 is engaged with a generally T-shaped walker or rocking lever 30, the function of which is described more fully in U.S. patent application Ser. No. 09/493,355, previously incorporated herein by reference. The lever 30 controls the movement of other parts, such as a mirror (not shown) disposed one each of the first and second arms of the lever 30. A cam follower 32 is formed on the central leg of the lever 30 and slideably engages the camed surface groove 10b of the cam gear 10. The cam gear 10 and lever 30 are structured and disposed so that rotational movement of a motor 40 is translated into lateral movement of the first and second lever arms. A fixed pivot pin 34 permits the lever 30 to pivot about the pin in response to rotation of the cam gear 10, and correspondingly, movement of the cam follower 32 in the cam groove 10b.

As the motor 40 rotates the shaft 42, the cog gear 45 engages and rotates a reduction gear 50. Reduction gear 50 engages and rotates a reduction gear 52. The reduction gear 52, in turn, engages and rotates the cam gear 10 at gear drive portion 10c. The cam follower 32 slideably engaged in the groove 10b pivots the lever 30 upon rotation of the cam gear 10, due to the shape of the groove 10b. Additionally, rotation of the cam gear rotates the cam wedge 10d, the leading/trailing edge of which closes the circuit between spring contact 20c and either stationary contact 20a or 20b, depending on the direction of rotation of the motor shaft 42. The reduction gears 50 and 52 and the cam gear 10 are held in position by guide pins (not shown). Note that the use of reduction gears 50 and 52 is not meant to be limiting. Rather, they may be omitted based on an appropriate choice of cog gear 45 and interconnecting cam gear 10.

The cam driven switch may be used as part of an overdrive protection mechanism for the apparatus controlled by the cam cylinder 10 and the lever 30. For example, the cam driven switch can function to stop the motor when the spring contact 20c engages either stationary contact 20a or 20b. This can be achieved by connecting the stationary contact to the input of a microprocessor that controls the operation of the motor 40, and the spring contact to the voltage source (or vice versa) so that a binary high (or low in the reverse situation) voltage level is detected at the input of the microprocessor. Alternatively, the motor voltage circuit may be set up so that closing the circuit between the spring contact and the stationary contact takes the motor voltage to the ground level.

Providing an overdrive protection mechanism prevents the cam gear 10 from over rotating and causing the mirrors attached to the lever 30 to be out of alignment. However this is not meant to be limiting. It can be seen how the cam driven switch of the present invention could be used for other purposes in systems using a cam gear of the same type as cam gear 10.

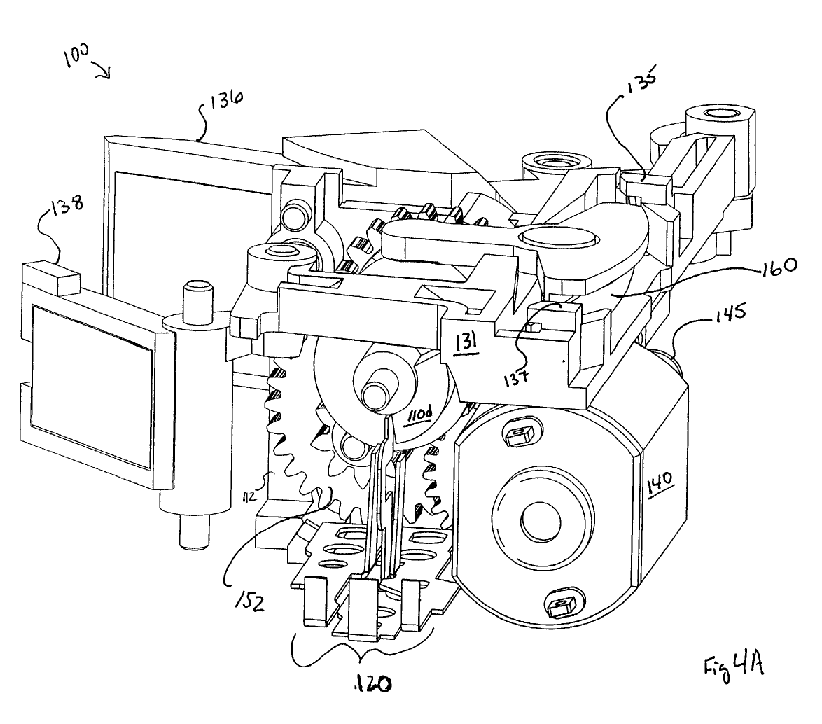

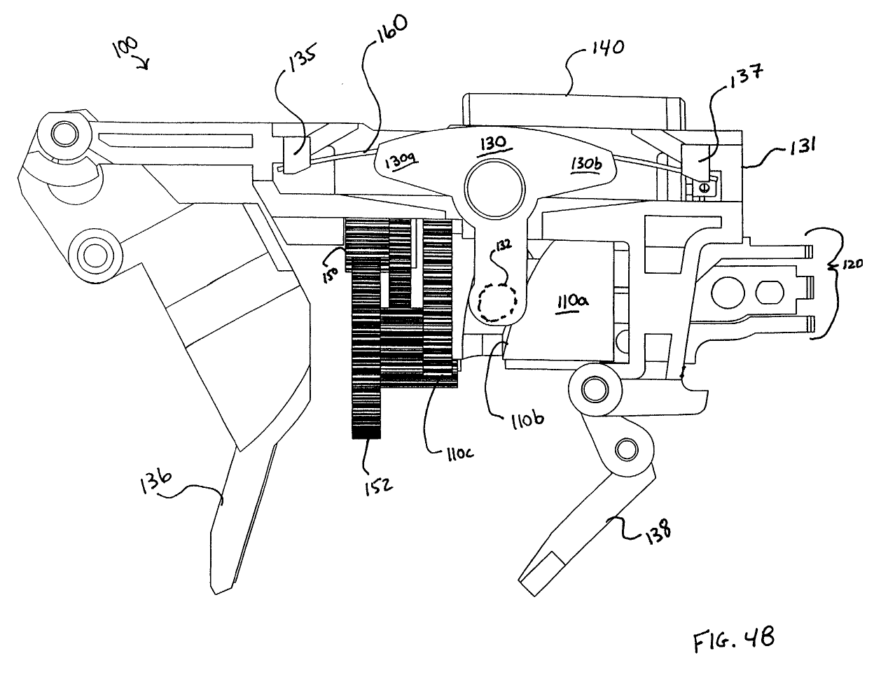

Referring now to FIGS. 4A and 4B, there is shown one particular exemplary system 100 using the cam driven switch of the present inventions, which example is further described in previously incorporated U.S. patent application Ser. No. 09/493,355. As in the simplified example 60 of FIG. 3, the current exemplary system 100 includes a cam gear 110 including a camed surface 110a having a cam groove 110b, a gear drive portion 110c and a cam wedge 110d. The cam gear 10 is part of the mechanism and drives a generally T-shaped lever. The cam wedge 110d cooperates with the switch 120 elements as described in connection with FIGS. 2A-3

In a present example, the movable mirrors 136 and 138 move together, in a coordinated manner. The output from the motor 140 is transmitted through the drive mechanism, which includes a series of gears 150, 152 and 110c and mechanical linkages, to move the two mirrors 136 and 138 together. As in the embodiment of FIG. 3, a cog gear 145 at the end of a motor shaft of motor 140 drives a reduction gear 150, which drives a second reduction gear 152 and correspondingly turns the cam gear 110. The cam gear 110 is connected to a generally T-shaped walker or rocking lever 130.

A cam follower 132 is formed on the central leg of the lever 130 and slideably engages a camed surface 110a of the cam gear 110. A first arm 130a of the lever 130 is mechanically connected to a first mirror holder 136 and the second opposite arm 130b is mechanically attached to another mirror holder 138. The cam gear 110 and lever 130 are structured and disposed so that rotational movement of the motor 140 is translated into lateral movement of the first 130a and second 130b arms from a first image framing mode position to a second image review mode position.

Additionally, as part of the overdrive protection mechanism of the present embodiment, the body member 131 that supports the lever 130 includes abutments 135 and 137. A leaf spring 160 is biased behind the lever 130 and the abutments 135 and 137. The leaf spring 160 is provided to account for slight over travel of the lever 130.

Further, to limit the rotation of the cam gear 110, fingers (not shown) on the drive support body 112 can be added to limit the rotation of the cam gear 110. These fingers interact with a stop groove on the outer face of the gear drive portion (i.e. stop groove 10f of FIG. 1) and the cam gear travel will stop when the stop block (10G of FIG. 1) and fingers make contact, thus preventing full rotation of the cam gear.

While the invention has been described with reference to a preferred embodiment, it will be understood by those skilled in the art that various changes may be made and equivalents may be substituted for elements thereof without departing from the scope of the invention. In addition, many modifications can be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A cam driven switch, comprising:
a cam gear, including,
a cylindrical outer surface bounded at a first end by a gear drive portion and at a second end by a cam face, at least a portion of said cylindrical outer surface including a cam groove defined through a portion of said cylindrical outer surface; and
a cam wedge located on said cam face, said cam wedge including at least a leading edge and a trailing edge; and
a switch including an open position and at least one closed position, wherein rotation of said cam gear brings at least a portion of said cam wedge into contact with said switch, closing said switch.

2. The cam driven switch of claim 1, wherein said switch includes at least a first stationary contact and a spring contact spaced apart from said stationary contact and wherein rotation of said cam gear by said gear drive portion brings at least one of said leading edge and said trailing edge into contact with said spring contact, causing said spring contact to contact said first stationary contact, closing said switch.

3. The cam driven switch of claim 2, wherein said switch additionally includes a second stationary contact spaced apart from said spring contact distal from said first stationary contact.

4. The cam driven switch of claim 3, wherein rotation of said cam gear in a first direction brings said leading edge into contact with said spring contact causing said first spring contact to contact said first stationary contact and wherein rotation of said cam gear in a second direction brings said trailing edge into contact with said spring contact causing said spring contact to contact said second stationary contact.

5. The cam driven switch of claim 3, wherein said spring contact is taller than said first stationary contact and said second stationary contact and wherein said cam wedge passes over at least one of said first stationary contact and said second stationary contact in order to contact said spring contact.

6. The cam driven switch of claim 4, wherein said cam gear is driven by a motor.

7. The cam driven switch of claim 6, wherein said motor is turned off when said spring contact contacts one of said first stationary contact and said second stationary contact.

8. The cam driven switch of claim 7 wherein the amount of rotation of said cam gear is defined by the angular distance between said leading edge and said trailing edge.

9. An overdrive protection mechanism in a system for driving a part including a cam follower, the overdrive protection mechanism comprising:
a cam gear, including,
a cylindrical outer surface bounded at a first end by a gear drive portion and at a second end by a cam face, at least a portion of said cylindrical outer surface including a cam groove defined through a portion of said cylindrical outer surface, the cam follower of the driven part interfacing with said cam groove; and
a cam wedge located on said cam face; and
a switch including an open position and at least one closed position, wherein rotation of said cam gear brings at least a portion of said cam wedge into contact with said switch, closing said switch;
a motor for rotating said cam gear about a rotational axis, wherein closing said switch stops said motor from rotating.

10. The overdrive protection mechanism of claim 9, wherein said switch includes at least a first stationary contact and a spring contact spaced apart from said stationary contact and said cam wedge includes at least a leading edge and a trailing edge and wherein rotation of said cam gear by said gear drive portion brings at least one of said leading edge and said trailing edge into contact with said spring contact, causing said spring contact to contact said first stationary contact, closing said switch.

11. The overdrive protection mechanism of claim 10, wherein said switch additionally includes a second stationary contact spaced apart from said spring contact distal from said first stationary contact and wherein rotation of said cam gear in a first direction brings said leading edge into contact with said spring contact closing said switch between said first spring contact and said first stationary contact and wherein rotation of said cam gear in a second direction brings said trailing edge into contact with said spring contact closing the switch between said spring contact and said second stationary contact.

12. The overdrive protection mechanism of claim 9, wherein the part driven by said cam gear is a generally T-shaped lever, a leg of said generally T-shaped lever including the cam follower.

13. The overdrive protection mechanism of claim 12, wherein a first arm of said generally T-shaped lever supports a first mirror and wherein a second arm of said generally T-shaped lever supports a second mirror.

14. The overdrive protection mechanism of claim 13, further includes a bias mechanism in contact with at least a portion of said first arm and at least a portion of said second arm to prevent said generally T-shaped lever from over rotating in response to rotation of said cam gear.

15. The overdrive protection mechanism of claim 14, wherein said bias mechanism includes a leaf spring.

16. The overdrive protection mechanism of claim 15, wherein said generally T-shaped lever is supported by a body member, said body member including a first abutment and a second abutment, a first end of said leaf spring being disposed behind said first abutment and a second end of said leaf spring being disposed behind said second abutment.

17. The overdrive protection mechanism of claim 9, wherein said cam gear is supported by a drive support body including a finger member and wherein the face of said gear drive portion includes a stop groove including a stop block disposed therein, said finger member engaging said stop groove to stop rotation of said cam gear when said finger member contacts said stop block.

18. A method for driving a cam gear for driving a part including a cam follower, comprising the steps of:
providing a cam gear in close proximity to a switch, said cam gear, including,
a cylindrical outer surface bounded at a first end by a gear drive portion and at a second end by a cam face, at least a portion of said cylindrical outer surface including a cam groove defined through a portion of said cylindrical outer surface, the cam follower of the driven part interfacing with said cam groove to translate rotational motion of said cam gear to linear motion of the part; and
a cam wedge located on said cam face;
rotating said cam gear until said cam wedge closes said switch; and
stopping rotation of said cam gear when said switch is closed.

19. The method of claim 18, wherein said cam gear is supported by a drive support body including a finger member and wherein the face of said gear drive portion includes a stop groove including a stop block disposed therein, said finger member engaging said stop groove to stop rotation of said cam gear when said finger member contacts said stop block.

20. An overdrive protection mechanism, comprising:
a generally T-shaped lever, including a first arm, a second arm and a central leg, said central leg including a cam follower;
a cam gear, including,
a cylindrical outer surface bounded at a first end by a gear drive portion and at a second end by a cam face, at least a portion of said cylindrical outer surface including a cam groove defined through a portion of said cylindrical outer surface, the cam follower of the driven part interfacing with said cam groove to translate rotational motion of said cam gear into linear motion of the part;
a bias mechanism in contact with at least a portion of said first arm and at least a portion of said second arm to prevent said generally T-shaped lever from over rotating in response to rotation of said cam gear.

21. The overdrive protection mechanism of claim 20, wherein said bias mechanism includes a leaf spring.

22. The overdrive protection mechanism of claim 21, wherein said generally T-shaped lever is supported by a body member, said body member including a first abutment and a second abutment, a first end of said leaf spring being disposed behind said first abutment and a second end of said leaf spring being disposed behind said second abutment.

23. The overdrive protection mechanism of claim 22, wherein a first arm of said generally T-shaped lever supports a first mirror and wherein a second arm of said generally T-shaped lever supports a second mirror.
